(19) United States
(12) Patent Application Publication
(10) Pub. No.: US 2024/0092023 A1
(43) Pub. Date: Mar. 21, 2024

(54) HEATING AND SENSING SYSTEM FOR USE WITH THREE-DIMENSIONAL PRINTING SYSTEMS

(71) Applicant: Sprintray Imc., Los Angeles, CA (US)

(72) Inventors: Huijian Tian, Los Angeles, CA (US); Aayush Patel, Los Angeles, CA (US); Anjali Daniels, Los Angeles, CA (US)

(21) Appl. No.: 17/990,256

(22) Filed: Nov. 18, 2022

Related U.S. Application Data
(60) Provisional application No. 63/408,063, filed on Sep. 19, 2022.

(51) Int. Cl. B29C 64/386; B29C 64/295; B33Y 30/00; B33Y 50/00; G05D 23/19; H05B 3/28

(52) U.S. Cl. CPC B29C 64/386; B29C 64/295; B33Y 30/00; B33Y 50/00; G05D 23/1931; H05B 3/28; H05B 2203/007

(57) ABSTRACT

A heating and sensing system for use with three-dimensional (3D) printing systems is provided. The heating and sensing system includes heating elements and/or sensor devices configured with a printing platform to set and sense the temperature of the platform. The system includes one or more controllers electrically configured with the heating elements and/or with the sensor devices via an electrical interface provided between the printing platform and a corresponding printer arm. The controller(s) are used to control the various elements of the system.

### PRIORITY AND RELATED APPLICATIONS

This application claims priority to and is a Non-Provisional application of U.S. Provisional Application No. 63/408,063, filed on Sep. 19, 2022, the disclosure of which is incorporated by reference in their entirety.

### FIELD OF THE INVENTION

This invention relates to three-dimensional (3D) printing systems, including a printing platform heating and sensing system for use with 3D printing systems.

### BACKGROUND

Three-dimensional (3D) printing systems have become popular throughout the world. With such systems, a three-dimensional object is printed onto a printing platform using photopolymer resin exposed to light.

Notably, the photopolymer resin also is affected by temperature. However, there are currently no systems available that enable the setting and controlling of the printing platform temperature. As such, this variable is currently not controlled during the 3D printing process.

Accordingly, there is a need for a heating and sensing system to set, control, and sense the temperature of a printing platform within a 3D printing system.

### SUMMARY

In one aspect of the invention, a system for use with a three-dimensional (3D) printing system is provided. The heating system may include: a printing platform including an outer build surface and an inner surface opposite the outer build surface; one or more heating elements configured with the inner surface; and a first controller electrically configured with the one or more heating elements and adapted to control the temperature of the one or more heating elements.

In some embodiments, the heating system also includes a sensor configured with the inner surface and adapted to sense the temperature of the inner surface. In some embodiments, the controller is electrically configured with the first sensor and adapted to trigger the first sensor to sense the temperature of the inner surface. In some embodiments, the printing platform includes a print arm coupling interface configured with a first electrical interface. In some embodiments, the heating system further incudes a print arm configurable with the printing platform at the print arm coupling interface, the print arm including a second electrical interface, wherein when the print arm is configured with the printing platform at the print arm coupling interface, the first and second electrical interfaces are electrically mated. In some embodiments, the controller is electrically connected to the second electrical interface and the one or more heating elements are electrically connected to the first electrical interface.

In some embodiments of the invention, a heating system may further include a second sensor configured with the first interface and/or the second interface and adapted to sense an electrical connection between the first and second interfaces. In some embodiments, a second controller electrically connected to the first electrical interface and/or with the one or more heating elements may be employed.

In some embodiments, the heating system may include a first sensor configured with the inner surface and adapted to sense the temperature of the inner surface, wherein second controller is electrically connected to the first sensor.

In some embodiments, the one or more heating elements are in physical contact with the inner surface. In some embodiments, the inner surface of the printing platform includes one or more support ribs defining one or more cells, and wherein the one or more heating elements is located in the one or more cells. In some embodiments, the one or more support ribs define a shape of the one or more cells, and the shape of the one or more heating elements is chosen to correspond to the shape of the one or more cells.

In one aspect of the invention, a system for use with a 3D printing system may include: a printing platform including an outer build surface; one or more heating elements configured to heat the outer build surface; and a first controller electrically configured with the one or more heating elements and adapted to control the temperature of the one or more heating elements. In some embodiments, a first sensor configured with the build surface and adapted to sense the temperature of the build surface. In some embodiments, the controller is electrically configured with the first sensor and adapted to trigger the first sensor to sense the temperature of the build surface.

In another aspect of the invention, a method is provided. The method may include a method of heating a printing platform build surface in a 3D printing system. The method may comprise the steps of: (A) providing a printing platform with an outer build surface and an inner surface opposite the outer build surface; (B) configuring one or more heating elements with the inner surface; (C) electrically configuring a first controller with the one or heating elements; (D) using the first controller to control the temperature of the one or more heating elements.

In some embodiments, the method may further include (E) configuring a first sensor with the inner surface; and (F) using the first sensor to sense the temperature of the inner surface. In some embodiments, the printing platform includes a print arm coupling interface configured with a first electrical interface, the method further comprising: providing a print arm configurable with the printing platform at the print arm coupling interface, the print arm including a second electrical interface; and (F) configuring the print arm with the printing platform at the print arm coupling interface thereby electrically mating the first electrical interface with the second electrical interface. In some embodiments, the method may include (E) configuring a second controller with the printing platform; and (F) electrically configuring the second controller with the one or more heating elements and/or with the first controller

In some embodiments, the method may further include (G) electrically configuring the first controller with the second electrical interface; and (H) electrically configuring the one or more heating elements with the first electrical interface.

In some embodiments, the method may further include (I) electrically configuring a first sensor with the first electrical interface and/or with the second electrical interface; and (J) using the first sensor to sense an electrical connection between the first electrical interface and the second electrical interface.

Various objects and advantages of the present invention will become apparent from the following description taken in conjunction with the accompanying drawings wherein are set forth, by way of illustration and example, certain embodiments of this invention. The drawings submitted herewith constitute a part of this specification, include exemplary embodiments of the present invention, and illustrate various objects and features thereof. The presently disclosed heating and sensing system and its method of use is more fully described in the detailed description below.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIGS. 1A-1B show aspects of a heating and sensing system configured with a print arm and a printing platform in accordance with exemplary embodiments hereof;

FIG. 2 shows aspects of a heating and sensing system configured with a print arm and a printing platform in accordance with exemplary embodiments hereof;

FIG. 3 shows aspects of a printing platform and a printer arm in accordance with exemplary embodiments hereof;

FIG. 4 shows aspects of a printing platform in accordance with exemplary embodiments hereof;

FIGS. 5-8 show aspects of a printing platform configured with heating elements in accordance with exemplary embodiments hereof;

FIG. 9 shows aspects of a printing platform and a printer arm in accordance with exemplary embodiments hereof;

FIG. 10 shows aspects of a printing platform in accordance with exemplary embodiments hereof;

FIGS. 11-12 show aspects of a printing platform configured with heating elements in accordance with exemplary embodiments hereof; and

FIGS. 13-14 show a printing platform and a printer arm in alignment with for proper configuration.

### DETAILED DESCRIPTION OF EXEMPLARY EMBODIMENTS

In general, the system and method according to exemplary embodiments hereof includes a heating and sensing system for use with three-dimensional (3D) printing systems. The heating and sensing system includes heating elements and/or sensor devices that may be configured with a printing platform to set and sense the temperature of the platform. The system may include one or more controllers electrically configured with the heating elements and/or with the sensor devices via an electrical interface provided between the printing platform and a corresponding printer arm. The controller(s) may be used to control the various elements of the system.

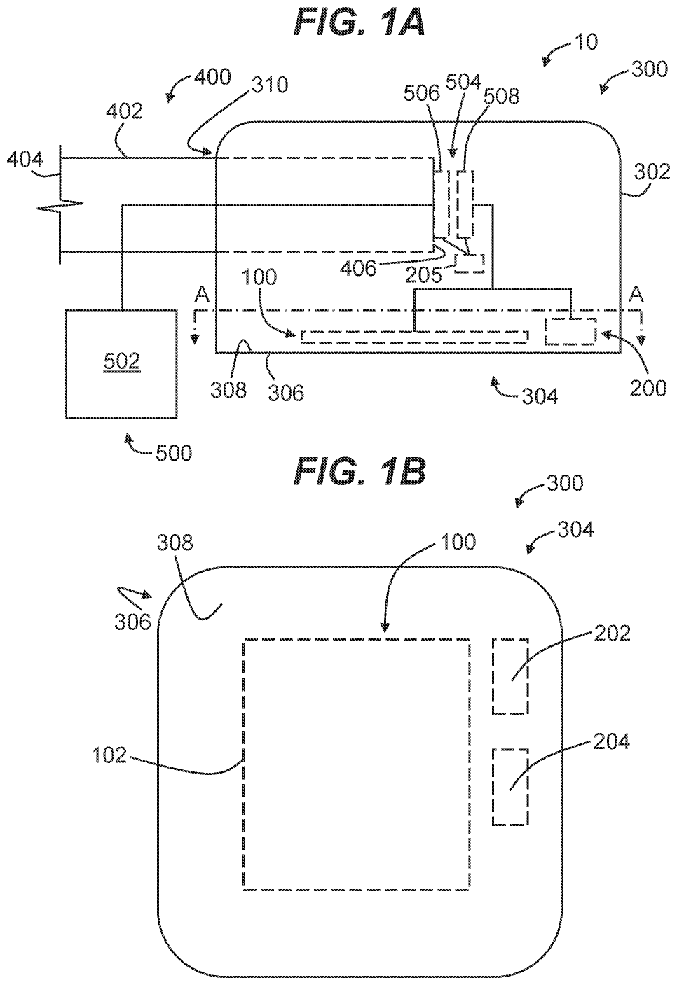

FIG. 1A shows a diagram of a platform heating and sensing system 10, and FIG. 1B shows a view of the system 10 of FIG. 1A taken from the perspective of the cutlines A-A.

In one exemplary embodiment hereof, as shown in FIGS. 1A-1B, the platform heating and sensing system 10 (also referred to herein as simply the system 10) includes a heating system 100 and a sensor system 200, each configured with a printing platform assembly 300 and a print arm assembly 400. The system 10 also includes a control system 500. In general, the heating assembly 100 provides heat to the platform assembly 400, and the sensor system 200 senses one or more parameters pertaining to the system 10 (e.g., the temperature of the platform assembly 300). The controller system 500 controls and generally interfaces with various elements of the system 10. In some embodiments, the sensor system 200 may be integrated into the heating system 100 and the control system 500 may simply interface with the heating system 100 accordingly. The system 10 also may include other elements as necessary for the system 10 to perform its functionalities as described herein or otherwise.

For the purposes of this specification, the assemblies 100, 200, 300, 400, 500 in FIGS. 1A-1B are represented as generic blocks for demonstration. However, is it understood that the assemblies 100, 200, 300, 400, 500 may be formed as any shapes as required for the assemblies 100, 200, 300, 400, 500 to perform their respective functionalities. It also is understood that the printing platform assembly 300 and the printer arm assembly 400 include all of the structures, components, and elements necessary to perform printing platform and/or printer arm functionalities, respectively, as is known in the art, in addition to the additional aspects of the system 10 as described herein.

In some embodiments, as shown in FIGS. 1A-1B, the printing platform assembly 300 includes a housing 302 with a build portion 304 including an outer surface 306 (e.g., the build surface or print surface) and an inner surface 308 within the build portion 304 opposite the outer surface 306 In addition, the heating system 100 includes one or more heating elements 102 placed in close proximity to, and preferably, in physical contact with, the build portion's inner surface 308. In this way, heat generated by the heating elements 102 may be transferred to the inner surface 308 (via conduction and/or convection) and in turn to the outer surface 306 via conduction through the build portion 304.

In some embodiments, as shown in FIGS. 1A-1B, the sensor system 200 includes one or more sensors 202 placed in close proximity to, and preferably, in physical contact with, the build portion's inner surface 308. In some embodiments, the sensors 202 include a temperature sensor 204 designed to read a temperature of the inner surface 308. Using this information, the system 10 may determine a temperature of the outer surface 306. In many cases, the build portion 304 may comprise a highly conductive material, e.g., metal, so that the temperature of the outer surface 306 may generally equal the temperature of the inner surface 308 such that no additional computations may be necessary for this determination.

In some embodiments, as shown in FIG. 1A, the control system 500 includes a first controller 502 configured with the heating system 100 and/or with the sensor system 200 via an electrical interface 504. The electrical interface 504 may include a first interface portion 506 and a second interface portion 508, that when mated, form the electrical interface 504. The first and second interface portions 506, 508 may include printed circuit boards (PCBs) with corresponding data pins, male and female jacks, other types of suitable interface portions, and any combinations thereof. In addition, the first controller 502 preferably includes one or more user interfaces (UIs) such as a display, keyboard, mouse, touchscreen, etc. As will be described in other sections, a user of the system 10 may use the first controller's UI to control or otherwise interface with the heating system 100 and/or with the sensor system 200 during use of the system 10 (e.g., to set and sense the temperature of the printing platform assembly 300).

In some embodiments, as shown in FIG. 1A, the print arm assembly 400 includes a print arm body 402 including a first end 404 (e.g., a proximal end) and a second end 406 (e.g., a distal end), with the second end 406 configured with the first interface portion 506. In addition, the printing platform assembly 300 may include a print arm coupler 310 (e.g., a cavity or channel) designed to receive and secure the second end 406 of the print arm body 402 including the first interface portion 506 configured thereto. The second interface portion 508 is configured at the printing platform's coupler 310 such that when the print arm body 402 is received at the coupler 310, the first and second interface portions 506, 508 may electrically mate thereby electrically connecting the first controller 502 with the heating system 100 and/or with the sensor system 200 via the interface 504.

It is understood that the first controller 502 may be electrically configured with the heating system 100 and/or the sensor system 200 using other arrangements, e.g., via a cable extending from the first controller 502 to the second interface portion 508, with the second interface portion 508 accessible on an outer surface of the printing platform's housing 302. Other arrangements also are contemplated, and it is understood that the scope of the system 10 is not limited in any way by the way in which the first controller 502 may be connected to the systems 100, 200.

In some embodiments, the first controller 502 interfaces with the heating system 100. For example, the first controller 502 may interface with the heating system 200 to set the outer surface 306 of the build portion 304 to a particular temperature. In this case, the first controller 502 may send an electronic command to the heating system 100 to set the heating elements 102 to the temperature. The heating elements 102 may receive the command and begin heating the outer surface 306 accordingly. In addition, if necessary, the heating system 100 may respond to the first controller 502 with a confirmation of the temperature setting.

In some embodiments, the first controller 502 interfaces with the sensor system 200. For example, the first controller 502 may interface with the temperature sensor 204 to check the temperature of the outer surface 306. In this case, the first controller 502 may trigger the temperature sensor 204 to take a temperature reading and to return information regarding the reading back to the controller 502. The first controller 502 may receive the temperature reading and compare it to the desired temperature set above. If the sensed temperature equals the desired temperature (e.g., plus or minus an acceptable threshold) the temperature setting procedure may be completed. However, if the temperature reading does not match the desired temperature within an acceptable threshold, the first controller 502 may command the heating element 102 to increase or decrease its temperature depending on the sensed reading. The first controller 502 may then trigger the temperature sensor 204 to take another temperature reading, and the process may continue until the desired temperature is confirmed.

In some embodiments, the first controller 502 may wait a predetermined amount of time between setting the temperature of the heating elements 102 and triggering the temperature sensor 202 to take a temperature reading. In this way, the heating elements 102 and the outside surface 306 may reach a steady state temperature prior to the temperature measurement. In some embodiments, the heating system 100 and/or the sensor system 200 may notify the first controller 502 when this steady state may be achieved.

It is understood that the examples described above are meant for demonstration and that the system 10 may take additional actions and/or may not take all of the actions described. It also is understood that the actions may be taken in different orders.

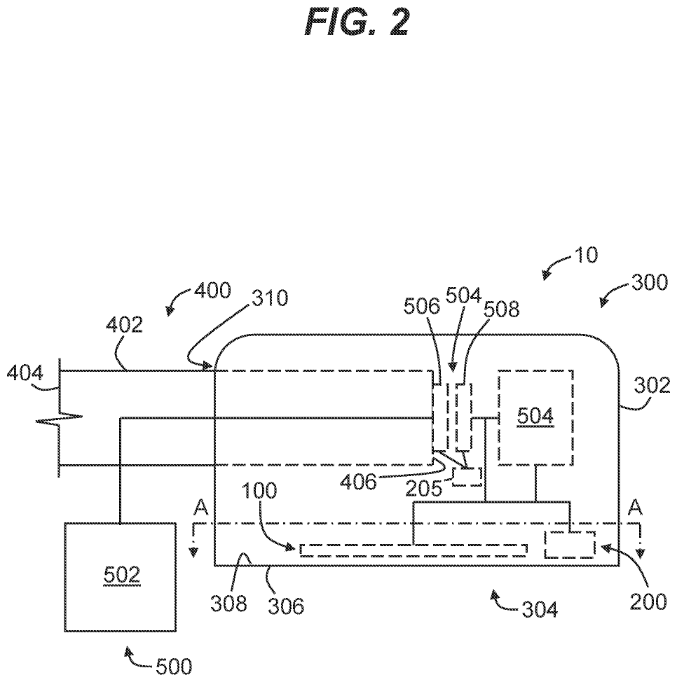

In some embodiments, as shown in FIG. 2, the system 10 may include a second controller 504 (e.g., a microcontroller, microprocessor, or other suitable controller) configured with the printing platform assembly 300. The second controller 504 may be electrically connected to the second interface portion 508, the heating system 100, and/or the sensor system 200. In this way, the first and second controllers 502, 504 may interface with one another, and the second controller 504 also may interface with the systems 100, 200. For example, the second controller 504 may take readings of the system 10 by interfacing with the one or more sensors 202 and relay the readings to the first controller 502 for analysis. In another example, the first controller 502 may instruct the second controller 504 to perform one or more activities with regards to the system 10, and the second controller 504 may act accordingly. It is understood that the first controller 502 and the second controller 504 may interface with one another for some activities and/or may operate independently of one another for other activities.

In some embodiments, as shown in FIGS. 1-2, the sensor system 200 includes a voltage sensor, a current sensor, and/or an impedance sensor 205 configured to sense the electrical connection between the first and second interface portions 506, 508. In this way, the sensor system 200 may determine when the printing platform assembly 300 and the print arm assembly 400 are properly mated. This information may be relayed to the first controller 502 and/or to the second controller 504 and provided to the user at the UI. In some embodiments, the system 10 may warn the user when the assemblies 300, 400 are not properly mated, and/or may disallow use of the 3D printing system until the assemblies 300, 400 are properly mated.

In some embodiments, the sensor system 200 includes other types of sensors 202, such as, without limitation, pressure sensors, vibration sensors, accelerometers, gyroscopes, other types of sensors, and any combinations thereof. The sensors 202 may comprise Micro Electro-Mechanical Systems (MEMS) and/or other types of sensor technologies.

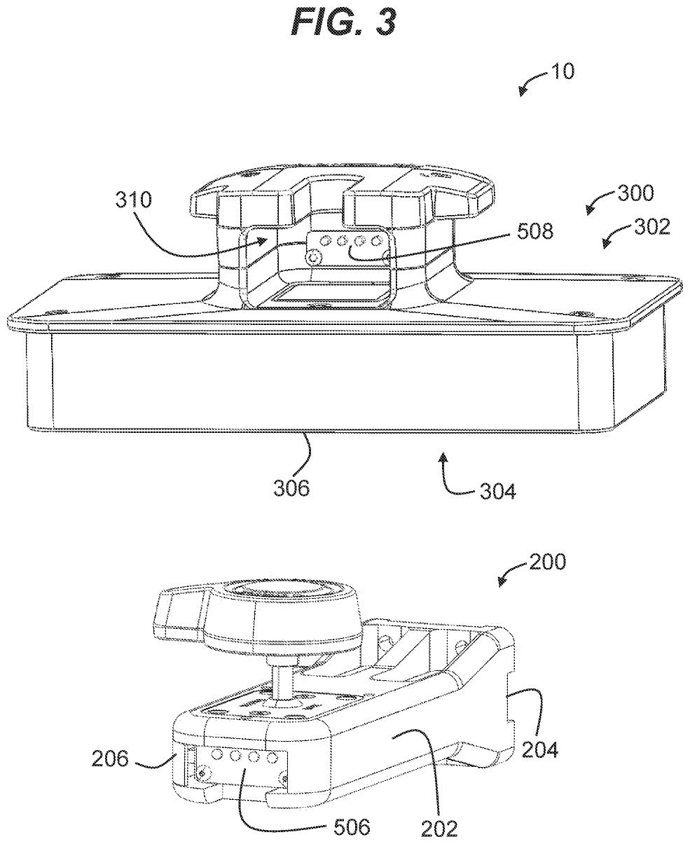

FIG. 3 shows a first exemplary printing platform assembly 300 and a corresponding exemplary print arm assembly 400. The printing platform assembly 300 includes a print arm coupler 310 (e.g., a cavity or channel) configured with the second interface portion 508, and the print arm assembly 400 includes a distal end 406 configured with the first interface portion 506. As will be described in other sections, the print arm assembly 400 may be inserted into the printing platform's print arm coupler 310 thereby electrically mating the first and second interface portions 506, 508.

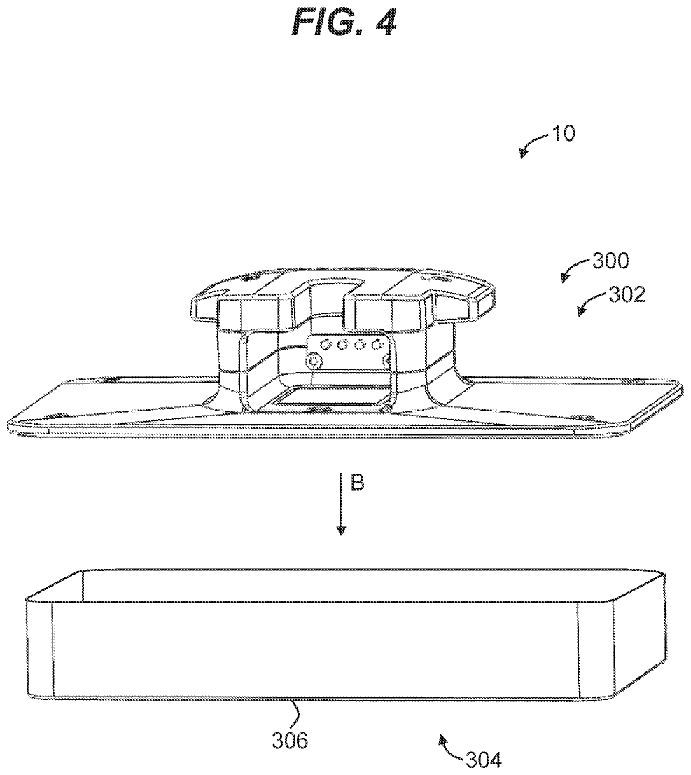

FIG. 4 shows the printing platform assembly 300 of FIG. 3 with the build portion 304 and its build surface 306 separated from the upper portion of the platform's housing 302.

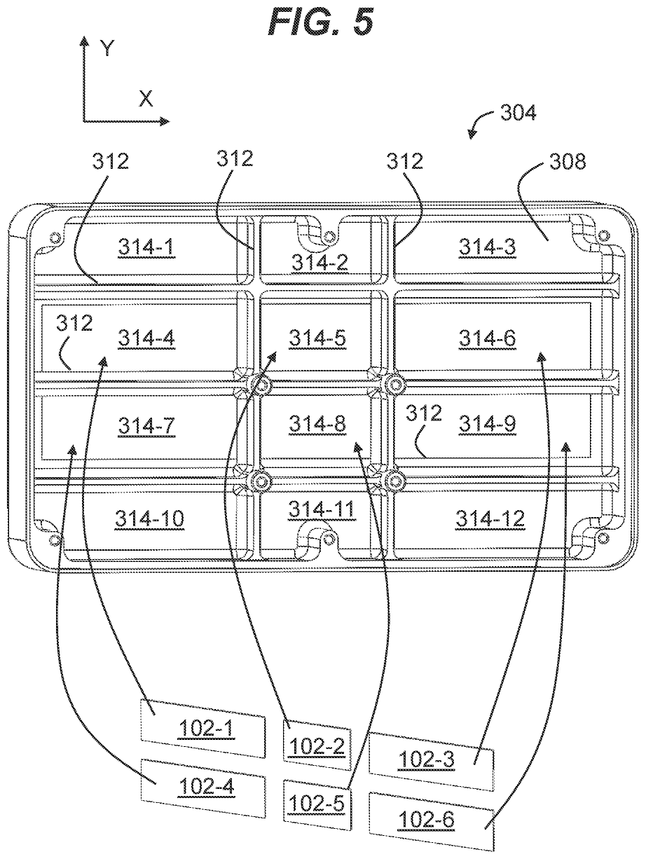

FIGS. 5-8 show top views (taken from the perspective of the arrow B in FIG. 4) of various exemplary internal build portion geometries of the printing platform assembly 300 of FIG. 4. Each of the FIGS. 5-8 show the corresponding heating elements 102 implemented within each respective build portion 304 as well as the heating elements 102 shown separately for clarity.

As shown in FIGS. 5-8, the build portion's inner surface 308 may include one or more support ribs 312 and/or one or more connection posts 313 (e.g., designed to receive bolts to secure the build portion 304 to the platform assembly 300). Between the support ribs 312 and/or the connection posts 313, the inner surface 308 may be generally exposed. The exposed portions of the inner surface 308 are referred to herein as cells 314. Accordingly, each heating element 102 may be configured to rest against the inner surface 308 within a respective cell 314.

In some embodiments, it may be preferable to heat at least the inner portion of the inner surface 308. In addition, it also may be preferable to maximize the amount of surface area within each cell 314 in physical contact with its respective heating element 102. Accordingly, the heating elements 102 may be custom-sized and shaped to fit within a respective call 314 to accommodate the support ribs 312 and/or the connection posts 313 and to cover a majority of surface area within the respective cell 314.

This critical aspect will be described by way of several detailed examples showing different build portion 304 internal geometries. The examples provided below are chosen to illustrate various embodiments and implementations of the heating elements 102 within the inner surface cells 314, and those of ordinary skill in the art will appreciate and understand, upon reading this description, that the examples are not limiting and that the heating elements 102 may be formed in different ways depending on the geometries of the build portions 304 being implemented. It also is understood that details of different embodiments described in different examples may be combined in any way to form additional embodiments all of which are within the scope of the system 10.

In a first example, as shown in FIG. 5, the internal geometry of the build portion 304 includes three support ribs 312 generally parallel to the X-axis and two support ribs 312 generally parallel to the Y-axis, thereby forming a matrix of twelve cells 314-1, 314-2, 314-3, . . . 314-12. In some embodiments, a first heating element 102-1 is positioned in the fourth cell 314-4, a second heating element 102-2 is positioned in the fifth cell 314-5, a third heating element 102-3 is positioned in the sixth cell 314-6, a fourth heating element 102-4 is positioned in the seventh cell 314-7, a fifth heating element 102-5 is positioned in the eighth cell 314-8, and a sixth heating element 102-6 is positioned in the ninth cell 314-9. In some embodiments, because the cells 314 are generally rectangular, the heating elements 102 also are rectangular of similar size.

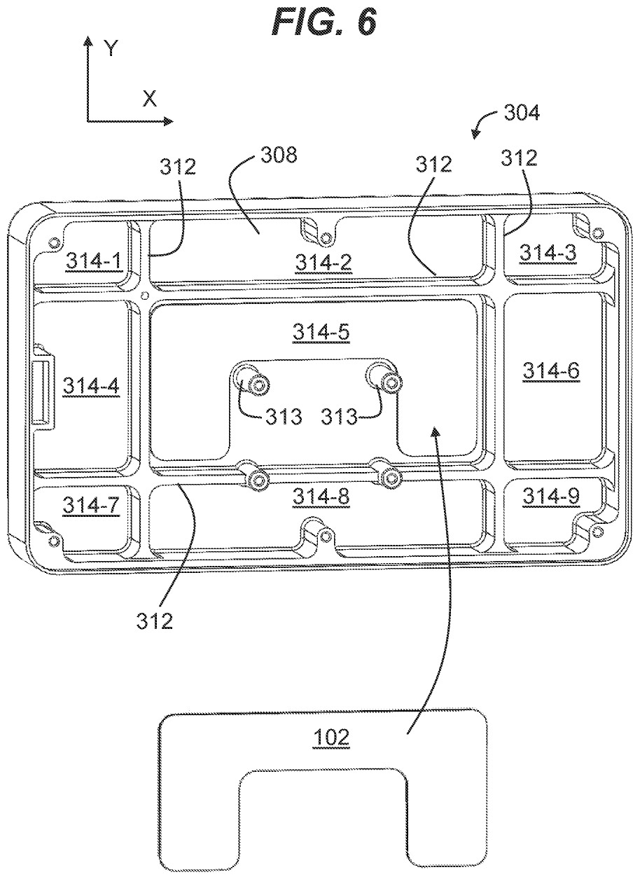

In a second example, as shown in FIG. 6, the internal geometry of the build portion 304 includes two support ribs 312 generally parallel to the X-axis and two support ribs 312 generally parallel to the Y-axis, thereby forming a matrix of nine cells 314-1, 314-2, 314-3, . . . 314-9. The internal geometry also may include two connection posts 313 within the central cell 314-5. For this geometry, the heating element 102 may be sized to fit within the central cell 314-5 and may include a lower cutout to accommodate the two connection posts 313 within the cell 314-5. Accordingly, the heating element 102 may resemble an upside-down U-shaped element. It also is contemplated that the heating element 102 include a cutout in its middle area to accommodate the posts 313, thereby resembling a rectangular donut. In addition, two or more heating elements 102 may be used to cover the surface area within the cell 314-5, e.g., a first rectangular element 102 may cover the area above the posts 318, a second rectangular element 102 may cover the area below the posts 318, and left and right elements 102 may cover the areas to the left and to the right of the posts 313, respectively.

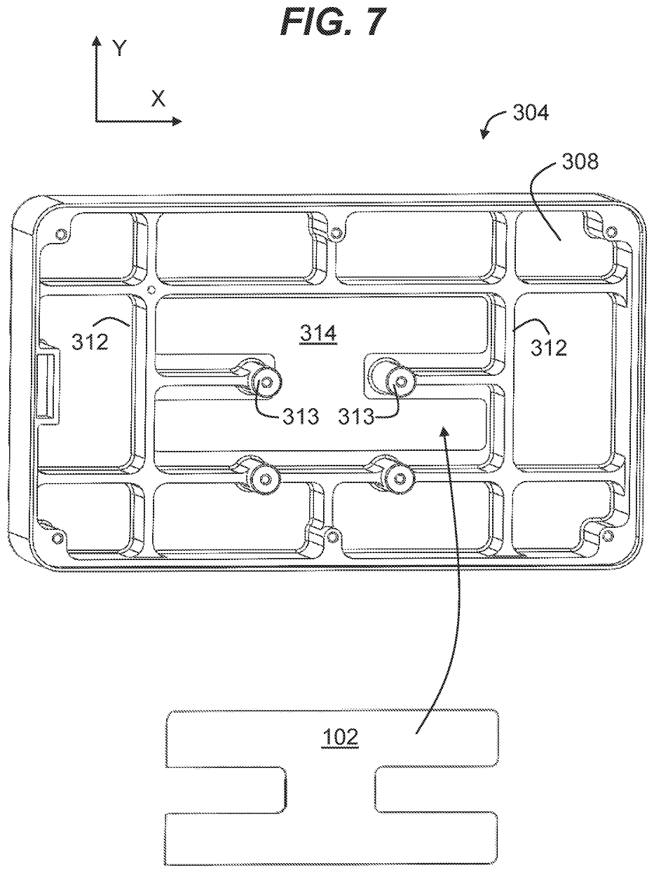

FIG. 7 shows a similar internal geometry as FIG. 6, with the heating element 102 shaped as a sideways H to accommodate the support ribs 312 and the connection posts 313 within the central cell 314.

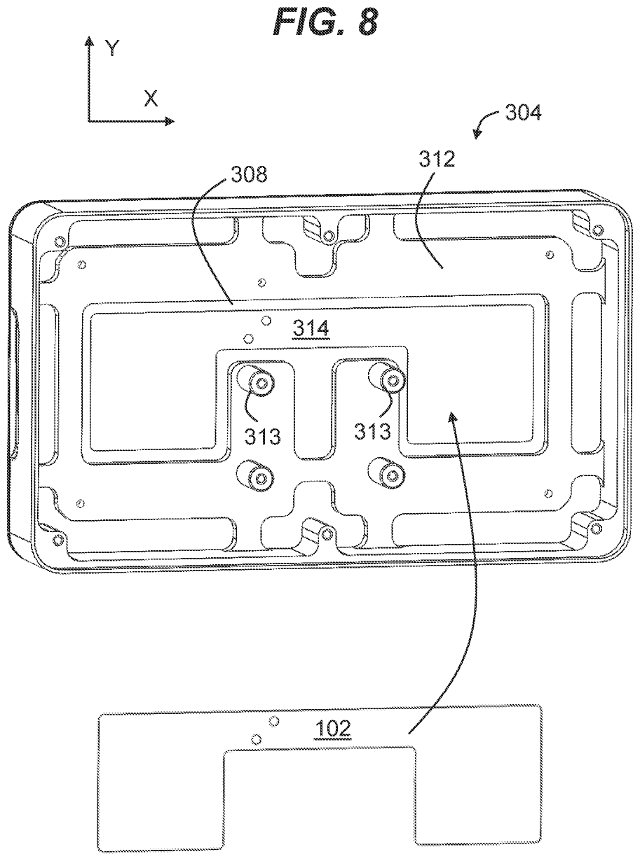

FIG. 8 shows a similar internal geometry as FIG. 6, with the heating element 102 shaped as an upside-down U to accommodate the support ribs 312 and the connection posts 313 within the central cell 314.

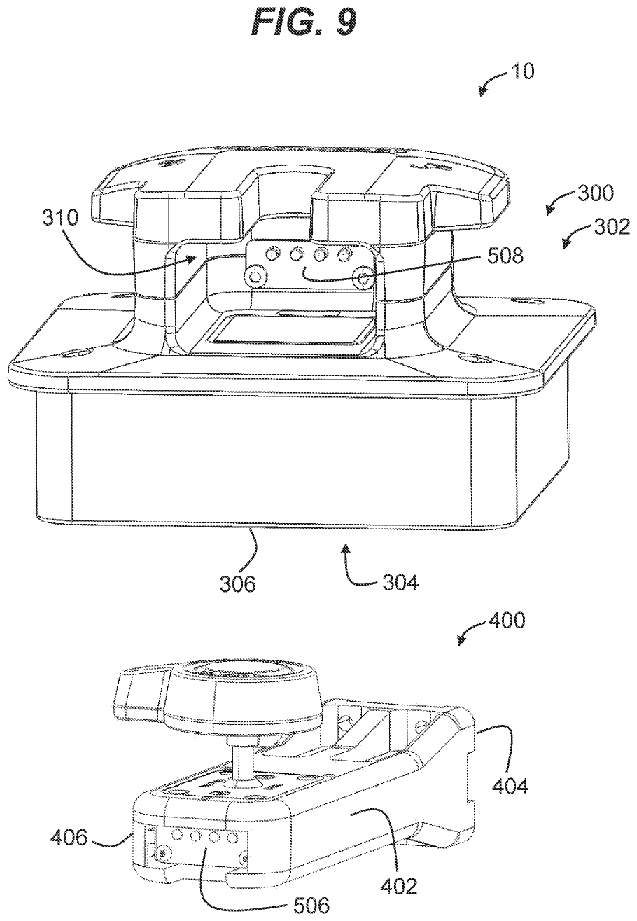

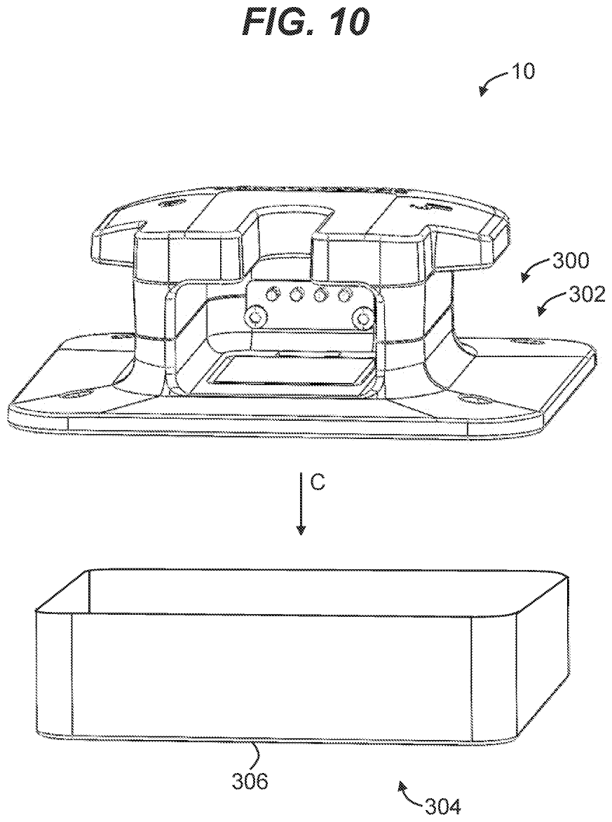

FIG. 9 shows a second exemplary printing platform assembly 300 and a corresponding exemplary print arm assembly 400. The printing platform assembly 300 includes a print arm coupler 310 configured with the second interface portion 508, and the print arm assembly 400 includes a distal end 406 configured with the first interface portion 506. FIG. 10 shows the printing platform 300 of FIG. 9 with the build portion 304 and its build surface 306 separated from the upper portion of the platform's housing 302.

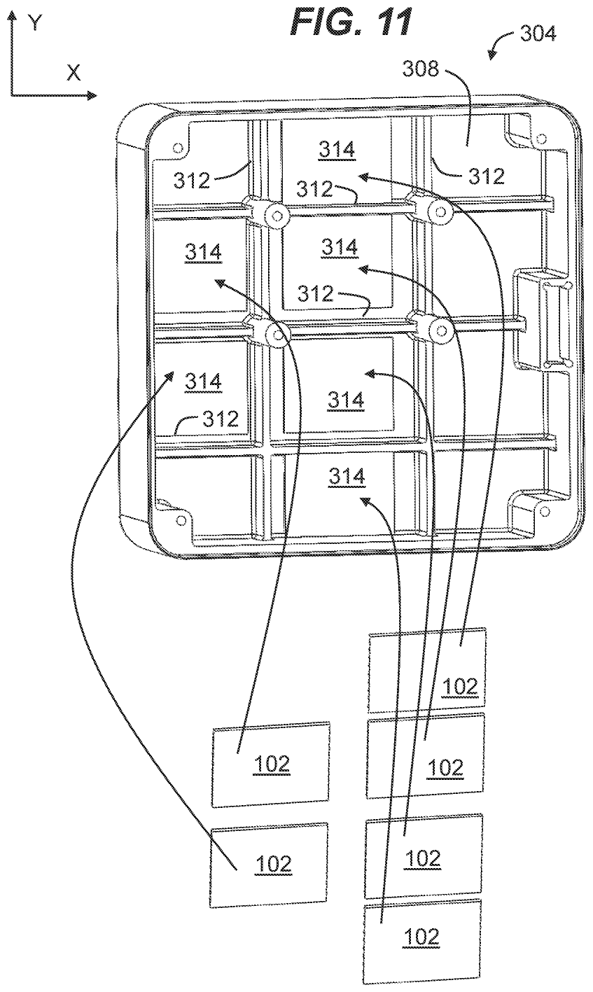

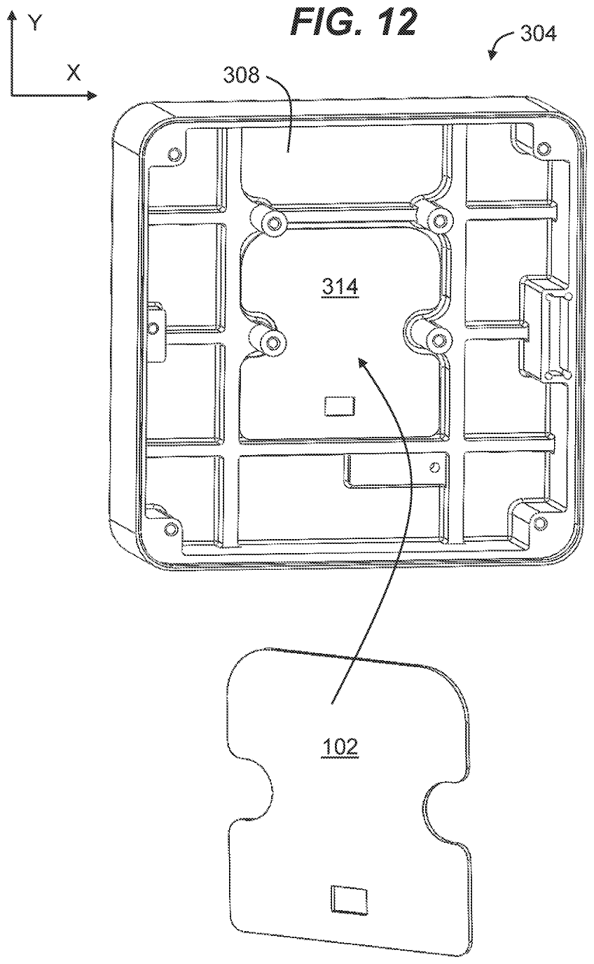

FIGS. 11-12 show top views (taken from the perspective of the arrow C in FIG. 4) of various exemplary internal build portion geometries of the printing platform assembly 300 of FIG. 9. Each of the FIGS. 11-12 show the corresponding heating elements 102 implemented within each respective build portion 304 as well as the heating elements 102 shown separately for clarity. The examples shown in FIGS. 11-12 are meant to complement the examples shown in FIGS. 5-8 as described above.

In the example shown in FIG. 11, a three-by-three matrix of nine cells 314 is formed by the support ribs 312 within the internal geometry. In this example, the heating elements 102 are formed as rectangles and sized to maximize the surface area coverage within each cell 314 by each respective heating element 102.

In the example shown in FIG. 12, the internal geometry includes a large central cell 314 with left and right connection posts 313 and rounded upper left and right corners. Accordingly, the heating element 102 is sized and shaped to maximize the surface area coverage within the cell 314 by including a rectangular shape with rounded upper left and right corners and side cutouts to accommodate the left and right connection posts 313.

In some embodiments, the heating elements 102 comprise polyimide film heating elements. One benefit of this type of heating element is its flexibility. Other types of heating elements 102 also may be use, such as, without limitation, cartridge heaters, ceramic heaters, other types of heating elements, and any combinations thereof. In some embodiments, the heating elements 102 may be rated at 2.5 W/in², 5 W/in², 10 W/in², or other ratings, with outputs of 50 W, 75 W, and other suitable outputs. In exemplary embodiments, a desired temperature of the heating element may depend on the type of resin being used for the particular 3D printing job, on the power or type of heating element, and generally should be a temperature suitable for the job at hand.

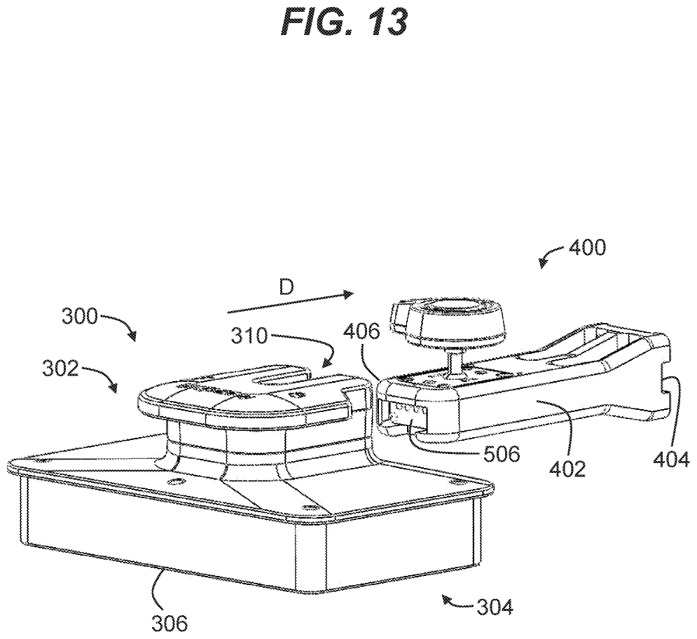

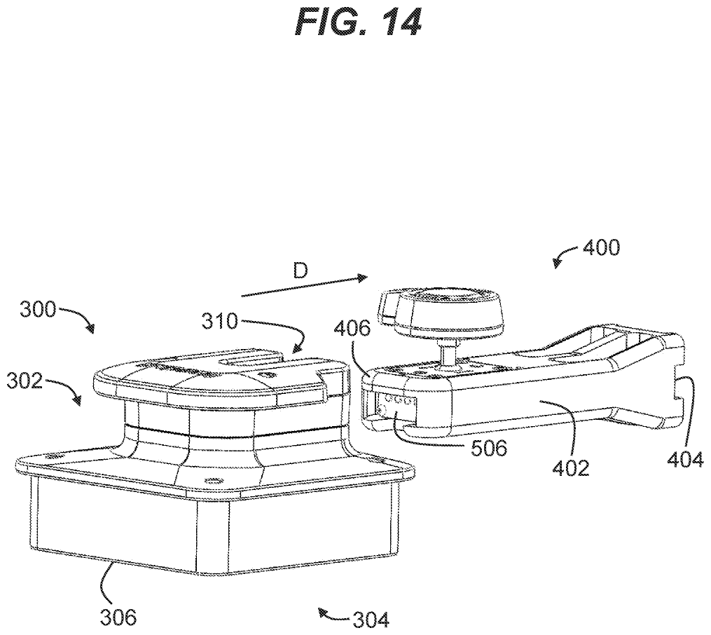

FIG. 13 shows the printing platform assembly 300 and print arm assembly 400 of FIG. 3, and FIG. 14 shows the printing platform assembly 300 and the print arm assembly 400 of FIG. 9, with each figure showing the assemblies 300, 400 positioned in alignment for proper connection with one another.

In some embodiments, as shown in FIGS. 13-14, the printing platform assembly 300 may be configured to the print arm assembly 400 by aligning the distal end 406 of the print arm body 402 with the print arm coupler 310 on the printing platform assembly 300 and moving the printing platform assembly 300 in the direction of the arrow D until the assemblies 300, 400 are mated and the first and second interface portions 506, 508 are electrically connected. In this configuration, the first controller 502 may be electrically connected to the heating system 100 and to the sensing system 200. In this way, the first controller 502 may interface with the heating system 100 and/or the sensing system 200 as described herein. If a second controller 504 is configured with the printing platform 300 as described herein, this arrangement also may electrically connect the first controller 502 to the second controller 504 such that the first and second controllers 502, 504 also may interface with one another.

It is understood that any aspect or element of any embodiment of the system 10 described herein or otherwise may be combined with any other aspect or element of any other embodiment of the system 10 to form additional embodiments of the system 10, all of which are within the scope of the system 10.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs,” and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only,” the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram, the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A heating system for use with a three-dimensional (3D) printing system, the heating system comprising:
a printing platform including an outer build surface and an inner surface opposite the outer build surface;
one or more heating elements configured with the inner surface; and
a first controller electrically configured with the one or more heating elements and adapted to control the temperature of the one or more heating elements.

2. The heating system of claim 1, further comprising:
a first sensor configured with the inner surface and adapted to sense the temperature of the inner surface.

3. The heating system of claim 2, wherein the controller is electrically configured with the first sensor and adapted to trigger the first sensor to sense the temperature of the inner surface.

4. The heating system of claim 1, wherein the printing platform includes a print arm coupling interface configured with a first electrical interface, the heating system further comprising:
a print arm configurable with the printing platform at the print arm coupling interface, the print arm including a second electrical interface;
wherein when the print arm is configured with the printing platform at the print arm coupling interface, the first and second electrical interfaces are electrically mated.

5. The heating system of claim 4, wherein the controller is electrically connected to the second electrical interface and the one or more heating elements is electrically connected to the first electrical interface.

6. The heating system of claim 4, further comprising:
a second sensor configured with the first interface and/or the second interface and adapted to sense an electrical connection between the first and second interfaces.

7. The heating system of claim 4, further comprising:
a second controller electrically connected to the first electrical interface and/or with the one or more heating elements.

8. The heating system of claim 7 further comprising:
a first sensor configured with the inner surface and adapted to sense the temperature of the inner surface;
wherein second controller is electrically connected to the first sensor.

9. The heating system of claim 1 wherein the one or more heating elements is in physical contact with the inner surface.

10. The heating system of claim 1 wherein the inner surface of the printing platform includes one or more support ribs defining one or more cells, and wherein the one or more heating elements is located in the one or more cells.

11. The heating system of claim 10 wherein the one or more support ribs define a shape of the one or more cells, and the shape of the one or more heating elements is chosen to correspond to the shape of the one or more cells.

12. A heating system for use with a three-dimensional (3D) printing system, the heating system comprising:
a printing platform including an outer build surface;
one or more heating elements configured to heat the outer build surface; and
a first controller electrically configured with the one or more heating elements and adapted to control the temperature of the one or more heating elements.

13. The system of claim 12, further comprising:
a first sensor configured with the build surface and adapted to sense the temperature of the build surface.

14. The system of claim 13, wherein the controller is electrically configured with the first sensor and adapted to trigger the first sensor to sense the temperature of the build surface.

15. A method of heating a printing platform build surface in a three-dimensional (3D) printing system, the method comprising:
(A) providing a printing platform with an outer build surface and an inner surface opposite the outer build surface;
(B) configuring one or more heating elements with the inner surface;
(C) electrically configuring a first controller with the one or heating elements;
(D) using the first controller to control the temperature of the one or more heating elements.

16. The method of claim 15, further comprising:
(E) configuring a first sensor with the inner surface;
(F) using the first sensor to sense the temperature of the inner surface.

17. The method of claim 15, wherein the printing platform includes a print arm coupling interface configured with a first electrical interface, the method further comprising:
(E) providing a print arm configurable with the printing platform at the print arm coupling interface, the print arm including a second electrical interface;
(F) configuring the print arm with the printing platform at the print arm coupling interface thereby electrically mating the first electrical interface with the second electrical interface.

18. The method of claim 17, further comprising:
(G) electrically configuring the first controller with the second electrical interface;
(H) electrically configuring the one or more heating elements with the first electrical interface.

19. The method of claim 18, further comprising:
(I) electrically configuring a first sensor with the first electrical interface and/or with the second electrical interface;
(J) using the first sensor to sense an electrical connection between the first electrical interface and the second electrical interface.

20. The method of claim 15, further comprising:
(E) configuring a second controller with the printing platform;
(F) electrically configuring the second controller with the one or more heating elements and/or with the first controller.
